(19) United States
(12) Patent Application Publication
(10) Pub. No.: US 2006/0280195 A1
(43) Pub. Date: Dec. 14, 2006

(54) Systems and methods for providing dedicated or shared network interface functionality via a single MAC

(75) Inventors: Pedro Lopez JR., Austin, TX (US); Timothy M. Lambert, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/149,669

(22) Filed: Jun. 10, 2005

(51) Int. Cl. H04J 3/22; H04J 3/16; H04L 12/66; H04L 12/56; H04L 12/28

(52) U.S. Cl. 370/419; 370/465

(57) ABSTRACT

An information handling system having a network interface system operable to provide optional dedicated or shared network interface functionality is provided. The network interface system includes (a) a motherboard including a LAN on motherboard (LOM), a first processor, and a first network port; and (b) a remote management card including a second network port and a second processor including a MAC device. A user may configured the network interface system for either a dedicated network interface mode or a shared network interface mode. In the dedicated mode, the MAC device and the second network port are coupled such that the second processor may communicate with a network management node via the second network port. In the shared mode, the MAC device and the LOM are coupled such that the second processor may communicate with the network management node via the first network port and the LOM.

### TECHNICAL FIELD

The present disclosure relates generally to information handling systems and, more particularly, to systems and methods for providing dedicated or shared network interface functionality via a single MAC.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems, such as some network servers, include a shared network interface card (NIC), in which a high bandwidth sideband interface to a LAN-on-motherboard (LOM) is used to connect a service processor or baseboard management controller (BMC) within the server to communicate management traffic across a network. Typically, management traffic travels through a dedicated NIC or via a relatively slow I2C-based sideband interface on the system LOM. A shared NIC may allow customers to use one less cable and network switch port. A high speed shared NIC allows for high bandwidth management traffic such as virtual medial and virtual KVM console redirection, for example.

### SUMMARY

Therefore, a need has arisen for systems and methods for providing user-selected dedicated or shared network interface functionality that reduce or eliminate problems associated with previous attempts to provide such functionality.

In accordance with one embodiment of the present disclosure, an information handling system operable to provide optional dedicated or shared network interface functionality is provided. The information handling system includes a network interface system including a motherboard and a remote management card. The motherboard includes a LAN on motherboard (LOM), a first processor, and a first network port operable to receive a first coupling device for communicatively coupling the first processor to one or more network nodes via the LOM. The remote management card includes a second network port and a second processor including a MAC device, the second network port operable to receive a second coupling device for communicatively coupling the second processor to one or more network nodes. The network interface system may be configured by a user for either a dedicated network interface mode or a shared network interface mode. In the dedicated network interface mode, the MAC device of the second processor is communicatively coupled to the second network port such that the second processor may communicate with a network management node via the second network port. In the shared network interface mode, the MAC device of the second processor is communicatively coupled to the first network port via the LOM of the motherboard such that the second processor may communicate with the network management node via the first network port.

In accordance with another embodiment of the present disclosure, a method for providing optional dedicated or shared network interface functionality is provided. A user interface is provided for selecting between a dedicated network interface mode and a shared network interface mode for a network interface system associated with an information handling system, the network interface system including a motherboard and a remote management card. The motherboard includes a LAN on motherboard (LOM), a first processor, and a first network port operable to receive a first coupling device for communicatively coupling the first processor to one or more network nodes via the LOM. The remote management card includes a second network port and a second processor including a MAC device, the second network port operable to receive a second coupling device for communicatively coupling the second processor to one or more network nodes. A selection of the dedicated network interface mode or the shared network interface mode for the network interface system is received from a user. Based on the selection received from the user, the network interface system is configured for either the dedicated network interface mode or the shared network interface mode. Configuring the network interface system for the dedicated network interface mode includes communicatively coupling the MAC device of the second processor to the second network port such that the second processor may communicate with a network management node via the second network port. Configuring the network interface system for the shared network interface mode includes communicatively coupling the MAC device of the second processor to the first network port via the LOM of the motherboard such that the second processor may communicate with the network management node via the first network port.

In accordance with yet another embodiment of the present disclosure, a computer-readable medium having computer-executable instructions for providing optional dedicated or shared network interface functionality is provided. The computer-executable instructions include instructions for providing a user interface for selecting between a dedicated network interface mode and a shared network interface mode for a network interface system associated with an information handling system, the network interface system including a motherboard and a remote management card. The motherboard includes a LAN on motherboard (LOM), a first processor, and a first network port operable to receive a first coupling device for communicatively coupling the first processor to one or more network nodes via the LOM. The remote management card includes a second network port and a second processor including a MAC device, the second network port operable to receive a second coupling device for communicatively coupling the second processor to one or more network nodes. The computer-executable instructions also include instructions for receiving from a user via the user interface a selection of the dedicated network interface mode or the shared network interface mode for the network interface system, and instructions for configuring the network interface system for either the dedicated network interface mode or the shared network interface mode based on the selection received from the user. Configuring the network interface system for the dedicated network interface mode includes communicatively coupling the MAC device of the second processor to the second network port such that the second processor may communicate with a network management node via the second network port. Configuring the network interface system for the shared network interface mode includes communicatively coupling the MAC device of the second processor to the first network port via the LOM of the motherboard such that the second processor may communicate with the network management node via the first network port.

One technical advantage of the present disclosure is that systems and methods are disclosed for providing a user the ability to select between a dedicated network interface mode or a shared network interface mode for communicating traffic (e.g. management traffic) across a network. Users may select either the dedicated or shared network interface mode, depending on various preferences of the user and advantages/disadvantages of each mode. For example, some users may select the dedicated mode to isolate management traffic from their main network, such as for security purposes, while other users may select the shared mode, such as to save the costs and cabling associated with extra network switch ports. In some embodiments, a server may be reconfigured for dedicated or shared network interface functionality any number of times, as desired by the relevant user(s).

Another technical advantage of the present disclosure is that a single physical MAC chip may be used to provide both dedicated and shared network interface functionality for a remote management card. Thus, the need for an additional MAC chip (which may be relatively expensive) may be eliminated, thus saving costs and circuit board real estate.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system including one or more servers having user-selected dedicated or shared network interface functionality according to one embodiment of the disclosure;

FIG. 2 illustrates a server of the system shown in FIG. 1, which server may be configured for either dedicated or shared network interface mode according to one embodiment of the disclosure; and

FIG. 3 illustrates a method of configuring the server of FIG. 2 for either dedicated or shared network interface mode according to one embodiment of the disclosure.

### DETAILED DESCRIPTION

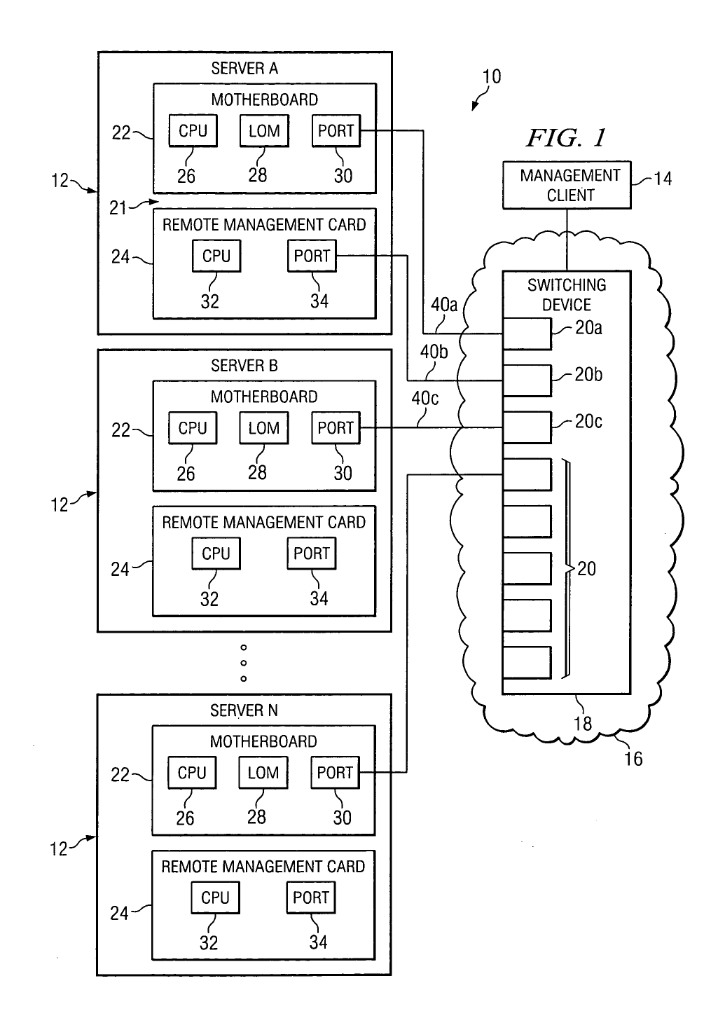

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 illustrates a system 10 including one or more servers 12 having user-optional dedicated or shared network interface functionality according to one embodiment of the disclosure. System 10 may also include one or more servers not having user-selected dedicated or shared network interface. However, this disclosure will focus on servers 12 having user-selected dedicated or shared network interface functionality.

As discussed in greater detail below, each server 12 may be configured by a user for either a dedicated or shared network interface mode for communication between a remote management card of that server 12 and an external communications network. In some embodiments, such optional dedicated or shared network interface mode may be provided for communication of out-of-band traffic (such as management traffic, for example) between a remote access card of that server 12 and a management client operable to manage various functionality of the relevant server 12. In such embodiments, each server 12 may include a motherboard having a LAN-on-motherboard (LOM) allowing the motherboard processor to communicate with an external network. In the dedicated network interface mode, the remote access card communicates out-of-band traffic with the management client via a first port associated with the remote access card, and the motherboard communicates in-band traffic with an external network via a second port associated with the motherboard. In the shared network interface mode, the remote access card communicates out-of-band traffic with the management client via the LOM and the second port of the motherboard, and the motherboard communicates in-band traffic with an external network via the second port. Thus, a single port may be used for communicating both in-band and out-of-band traffic to the remote access card and the motherboard processor, respectively. Thus, a single physical coupling device (e.g., cable) may be used to connect server 12 to the network. In addition, only one network port (e.g., switch or router port) needs to be managed to provide both in-band and out-of-band traffic to server 12, thus saving management resources.

As shown in FIG. 1, system 10 includes a number of servers 12 (servers A-n) coupled to a management client 14 via one or more communications networks 16. Each server 12 and management client 14 may include one or more information handling systems, as defined herein. Each server 12 may be any type of server and may provide any type of functionality associated with a server, such as database management, transaction processing, or web server functionality, for example. Communications network(s) 16 may include any local area network (LAN), metropolitan area network (MAN), wide area network (WAN), wireless local area network (WLAN), virtual private network (VPN), intranet, the Internet, or any other appropriate architecture or system that facilitates the communication of data. In the example system shown in FIG. 1, communications network 16 includes a switching device 18 to which each server 12 is communicatively coupled. Switching device 18 may be a switch, router, hub or any other device having commutations switching functionality, and may include any suitable number of ports 20 for communicating with servers 12 and/or various other devices. Switching device 18 may be coupled to management client 14 via any number and types of devices within communications network 16. In addition, in other embodiments, one or more servers 12 may be coupled to devices within communications network 16 other than switching device 18.

Each server 12 may include a network interface system 21 including a motherboard 22 and a remote management card (RMC), or remote access card, 24.

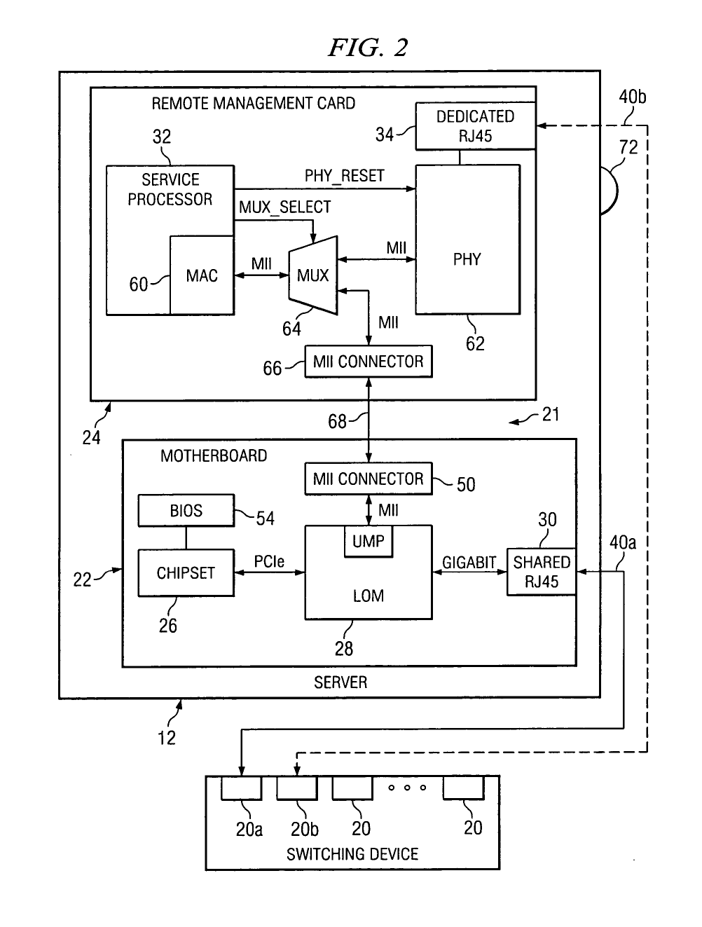

Each motherboard 22 may include a processor 26, a LAN-on-motherboard (LOM) 28, a motherboard network port 30, and any other suitable devices. Each RMC 24 may include a processor 32 and a RMC network port 34. The components of motherboard 22 and RMC 24 are discussed in greater detail below with reference to FIG. 2.

As shown in FIG. 1, each server 12 is communicatively coupled to switching device 18 by one or more coupling devices (e.g. cables or wires) 40. In particular, each server 12 is coupled to switching device 18 (for communication between that server 12 and any suitable external devices via network 16) either by one or two cables, depending on the network interface mode selected for that server 12, namely either (a) a dedicated network interface mode or (b) a shared network interface mode. A server 12 in the dedicated network interface mode, such as Server A, may be connected to switching device 18 by (a) a first cable 40 connecting 20 motherboard network port 30 to a port 20 of switching device 18, and (b) a second cable 40 connecting RMC network port 34 to another port 20 of switching device 18. A server 12 in the shared network interface mode, such as Server B, may be connected to switching device 18 by a single cable 40 connecting motherboard network port 30 to a single port 20 of switching device 18. In the selected mode, RMC 24 may communicate with switching device 18 via motherboard 22, and thus need not be connected to switching device 18 via RMC network port 34, thus eliminating the need for cable(s) 40 between RMC network port 34 and switching device 18 and freeing up a port 20 of switching device 18. RMC 24 may be communicatively coupled to motherboard 22 via any one or more interfaces 42, such as a sideband interface, for example. In a particular embodiment, RMC 24 is communicatively coupled to motherboard 22 via a media-independent interface (MII).

In the embodiment shown in FIG. 1, Server A, which is configured in the dedicated network interface mode, may communicate in-band traffic between motherboard processor 26 and one or more network devices via a first cable 40a and out-of-band traffic between RMC processor 32 and management client 14 (and/or one or more network devices) via a second cable 40b. The in-band traffic may be communicated from one or more network devices, to switching device 18, to first cable 40a via port 20a, to motherboard network port 30, to LOM 28, and then to motherboard processor 26, and vice versa. In-band traffic may include any traffic related to the operational functionality of the particular server (here, server A), such as web page data or data for database management, for example. The out-of-band traffic may be communicated from management client 14 (and/or one or more network devices), to switching device 18, to second cable 40b via port 20b, to RMC network port 34, and to RMC processor 32, and vice versa. Out-of-band traffic may include any traffic generally not related to the operational functionality of the particular server (here, server B), such as server management traffic, for example. For example, management client 14 may communicate management traffic with RMC 24 in order to configure, update, adjust, monitor, or otherwise manage various settings or other parameters of the particular server (here, server B).

The dedicated network interface mode may provide various advantages as compared to the shared network interface mode. For example, because the out-of-band traffic and in-band traffic is communicated to and from server 12 by separate physical channels (e.g. separate cables 40) in the dedicated mode, the dedicated mode may provide more control over the traffic being communicated to and from the server 12. Thus, the communication of management traffic between RMC 24 and management client 14 may be more secure in the dedicated mode as compared to the shared mode.

Unlike Server A, Server B, which is configured in the shared network interface mode, may communicate both in-band traffic and out-of-band traffic through motherboard network port 30, and thus through a single cable 40c connecting server B with switching device 18. RMC processor 32 is communicatively coupled to LOM 28, and LOM 28 is able to differentiate and route in-coming traffic to motherboard processor 26 or RMC processor 32, as appropriate. In particular, LOM 28 may be able to differentiate traffic received along a PCI bus or PCI express bus on the host side, as well as traffic received along a gigabit or other network interface on the network side, and internally re-route out-of-band management traffic out of a sideband interface to RMC 24. Thus, in-band traffic may be communicated from one or more network devices, to switching device 18, to cable 40c via port 20c, to motherboard network port 30, to LOM 28, and then forwarded by LOM 28 to motherboard processor 26, and vice versa. Out-of-band traffic may be communicated from management client 14 (and/or one or more network devices), to switching device 18, to cable 40c via port 20c, to motherboard network port 30, to LOM 28, and then forwarded by LOM 28 to RMC processor 32 via interface 42, and vice versa. Thus, both motherboard processor 26 and RMC processor 32 may communicate with external devices via LOM 28 and via a single cable 40c.

The shared network interface mode may provide various advantages as compared to the dedicated network interface mode. For example, because only one switching device port 20 is required by a server 12 in the shared mode (as opposed to two ports 20 in the dedicated mode), the administration or management costs associated with managing physical ports 20 at switching device 18 may be reduced. In addition, only a single physical cable 40 may be need to connect server 12 in the shared mode to switching device 18. Both of these factors correspond to reduced network complexity, which may be desired by many users.

A user of a particular server 12 may select to configure network interface system 21 to operate in either the dedicated network interface mode or the shared network interface mode. Thus, the user may select either the dedicated or shared network interface mode, depending on various preferences of the user and advantages/disadvantages of each mode, such as those discussed above. In some embodiments, network interface system 21 may be reconfigured for either mode at any (or specific) time during the operation of the server 12. The server 12 may or may not need to be rebooted to implement such reconfigurations. In some embodiments, network interface system 21 may be reconfigured once by a user. In other embodiments, network interface system 21 may be reconfigured any number of times as desired by a user or users.

FIG. 2 illustrates a server 12 of system 10 of FIG. 1, which server 12 may be configured in either a dedicated or shared network interface mode according to one embodiment of the disclosure. As discussed above, server 12 includes network interface system 21 including motherboard 22 and RMC 24. Motherboard 22 includes processor 26, LOM 28, motherboard network port 30, a media-independent interface (MII) connector 50, and any other suitable devices. In this embodiment, motherboard network port 30 includes an RJ45 connector for Ethernet functionality. However, motherboard network port 30 may include any other suitable devices, such other present and future networking standards and interfaces, such as fiber optic connection devices, for example.

In the particular embodiment shown in FIG. 2, motherboard network port 30 is connected to LOM 28 by a Gigabit Ethernet connection, LOM 28 is connected to processor 26 by a PCIe connection, and MII connector 50 is connected to a sideband port (e.g. a high-speed Universal Management Port (UMP)) 52 of LOM 28 by a MII connection. However, in other embodiments, any other suitable configurations and connections of motherboard components may be used. Motherboard 22 also includes a basic input/output system (BIOS) program 54 stored in memory and accessible by processor 26. BIOS program 54 may include software operable to control a plurality of server operations and configurations. In particular embodiments, BIOS program 54 includes software operable to facilitate selection by a user between the dedicated network interface mode and the shared network interface for network interface system 21.

RMC 24 includes a processor 32, a MAC chip 60 embedded in processor 32, a PHY chip 62, a multiplexer (MUX) 64, a MII connector 66, and RMC network port 34. In this embodiment, processor 32 is a service processor. However, processor 32 may include any type of processor, such as a baseboard management controller (BMC), for example. In this embodiment, MAC chip 60 is an embedded or integrated Ethernet MAC, and RMC network port 34 includes an RJ45 connector for Ethernet functionality. However, as discussed above regarding motherboard network port 30, RMC network port 34 may include any other suitable devices, such other present and future networking standards and interfaces, such as fiber optic connection devices, for example. PHY chip 62 is communicatively coupled to RMC network port 34 and is generally operable to translate between MII communications and communication protocols used over cables 40 (e.g. twisted pair signaling protocols), and vice versa. MII connector 66 is coupled to MII connector 50 of motherboard 22 via a cable or other coupling device 68.

MUX 64 is communicatively coupled to MAC chip 60, PHY chip 62 and MII connector 66 by MII connections such that MUX may be switched between (a) a first state, corresponding with the dedicated network interface mode, which allows communication between MAC chip 60 and PHY chip 62, but not between MAC chip 60 and MII connector 66; and (b) a second state, corresponding with the shared network interface mode, which allows communication between MAC chip 60 and MII connector 66, but not between MAC chip 60 and PHY chip 62. Thus, when MUX 64 is configured in the first state for the dedicated network interface mode, data (e.g. management traffic) may be communicated between service processor 32 and switching device 18 via MUX 64, PHY chip 62, RMC network port 34, and cable 40b.

Alternatively, when MUX 64 is configured in the second state for the shared network interface mode, data (e.g. management traffic) may be communicated between service processor 32 and switching device 18 via MUX 64, MII connector 66, cable 68, MII connector 50, LOM 28, motherboard network port 30, and cable 40a. In particular, in the shared mode, LOM 28 may differentiate management traffic from in-band traffic received along the gigabit or other network interface via motherboard network port 30, and (a) route in-band traffic to motherboard processor 26 and (b) route out-of-band management traffic to RMC 24 via sideband UMP interface 52.

Thus, both dedicated and shared network interface functionality for a remote management card 24 may be provided using a single physical MAC chip 60, rather than separate MAC chips for such dedicated and shared network interface functionality. Thus, the need for an additional MAC chip (which may be relatively expensive) may be eliminated, thus saving costs and circuit board real estate. Also, as discussed above, since a user of server 12 may select to configure of server 12 to operate in either the dedicated network interface mode or the shared network interface mode, the user of server 12 is given the choice of how to route the management traffic for server 12 according to the user's preferences.

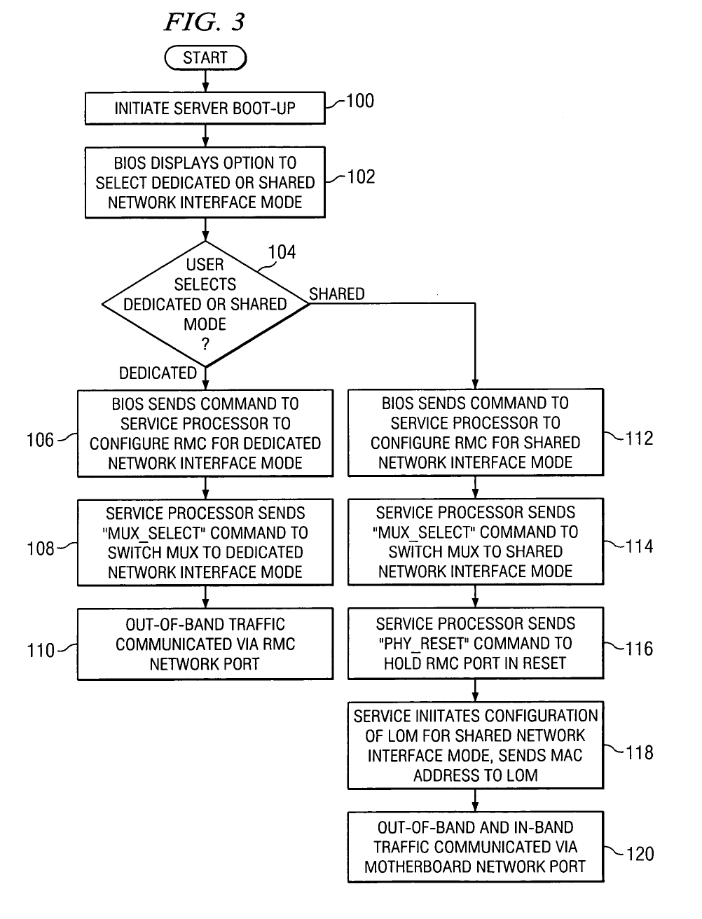

FIG. 3 illustrates a method of configuring server 12 shown in FIG. 2 for either a dedicated or shared network interface mode according to one embodiment of the disclosure. At step 100, a user of server 12 initiates a boot-up of server 12, such as by powering-up or re-starting server 12, for example. At step 102, during the boot-up process, BIOS program 54 may display one or more menu screens to the user. A particular BIOS configuration screen may provide the user an option to select either the dedicated network interface mode or the shared network interface mode. At step 104, the user uses an input device, such as a keyboard, mouse or pointer, to select either the dedicated or shared network interface mode.

If the user selects the dedicated network interface mode at step 104, BIOS program 54 may send a command to service processor 32 at step 106 to configure RMC 24 for the dedicated network interface mode. In response, at step 108, service processor 32 may perform various functions, such as loading one or more appropriate device drivers or executing particular code, to configure RMC 24 for the dedicated network interface mode. For example, service processor 32 may send a command, indicated as “MUX_SELECT” command in FIG. 2, to MUX 64 to cause MUX 64 to operate in the dedicated network interface mode (i.e., to allow communication between MAC chip 60 and PHY chip 62, but not between MAC chip 60 and LOM 28). After the configuration for the dedicated mode, at step 110, out-of-band traffic may be communicated to and from service processor 32 via RMC network port 34 during the operation of server 12. For example, management traffic may be communicated between service processor 32 and management client 14 via RMC network port 34. In-band traffic may be communicated to and from motherboard processor 26 via motherboard network port 30.

If the user selects the shared network interface mode at step 104, BIOS program 54 may send a command to service processor 32 at step 112 to configure RMC 24 for the shared network interface mode. In response, service processor 32 may perform various functions, such as loading one or more appropriate device drivers or executing particular code, to configure RMC 24 for the shared network interface mode. For example, at step 114, service processor 32 may send a command, indicated as “MUX_SELECT” command in FIG. 2, to MUX 64 to cause MUX 64 to operate in the shared network interface mode (i.e., to allow communication between MAC chip 60 and LOM 28, but not between MAC chip 60 and PHY chip 62). At step 116, service processor 32 may also send a command, indicated as “Phy_Reset” command in FIG. 2, to PHY chip 62 to hold RMC network port 34 in reset such that an indicator 72 associated with RMC network port 34 indicates that RMC network port 34 is deactivated. For example, indicator 72 may be a link light or activity light indicating whether RMC network port 34 is activated or deactivated, and the “Phy_Reset” command may prevent the light from coming on, even when a cable 40 is plugged into RMC network port 34. Thus, notice may be provided to users that RMC network port 34 is inactive (i.e., that both in-band and out-of-band traffic is being communicated through motherboard network port 30).

At step 118, service processor 32 may communicate with LOM 28 to configure LOM 28 for the shared network interface mode, including sending the MAC address of MAC chip 60 to LOM 28, which MAC address may be communicated to switching device 18 such that switching device 18 may route traffic intended for RMC 24 to motherboard network port 30. After the configuration for the dedicated mode, at step 120, both in-band and out-of-band traffic may be communicated to and from server 12 via motherboard network port 30. In particular, LOM 28 may differentiate in-band from out-of-band traffic received from switching device 18 via motherboard network port 30 and route the in-band traffic to motherboard processor 26 and the out-of band traffic (e.g. management traffic from management client 14) though sideband interface 52 to service processor 32.

Although the disclosed embodiments have been described in detail, it should be understood that various changes, substitutions and alterations can be made to the embodiments without departing from their spirit and scope.

What is claimed is:

1. An information handling system operable to provide optional dedicated or shared network interface functionality, comprising:
a network interface system including:
a motherboard including a LAN on motherboard (LOM), a first processor, and a first network port operable to receive a first coupling device for communicatively coupling the first processor to one or more network nodes via the LOM; and
a remote management card including a second network port and a second processor including a MAC device, the second network port operable to receive a second coupling device for communicatively coupling the second processor to one or more network nodes;
wherein the network interface system may be configured by a user for either a dedicated network interface mode or a shared network interface mode;
wherein in the dedicated network interface mode, the MAC device of the second processor is communicatively coupled to the second network port such that the second processor may communicate with a network management node via the second network port; and
wherein in the shared network interface mode, the MAC device of the second processor is communicatively coupled to the first network port via the LOM of the motherboard such that the second processor may communicate with the network management node via the first network port.

2. The information handling system of claim 1, wherein the remote management card further includes a multiplexer device operable to be configured by the user to a first state corresponding to the dedicated network interface mode or to a second state corresponding to the shared network interface mode;
wherein in the first state of the multiplexer device, the multiplexer device allows communication between the MAC device of the second processor and the second network port, but not between the MAC device of the second processor and the LOM of the motherboard; and
wherein in the second state of the multiplexer device, the multiplexer device allows communication between the MAC device of the second processor and the LOM of the motherboard, but not between the MAC device of the second processor and the second network port.

3. The information handling system of claim 2, wherein the second processor of the remote management card is operable to:
generate a configuration command for controlling the switching of the multiplexer device to either the first state or the second state in response to a configuration selection received from the user; and
communicate the configuration command to the multiplexer device to switch the multiplexer device to the desired state.

4. The information handling system of claim 2, wherein the remote management card further includes:
an indicator operable to indicate to a user whether the second network port is activated or deactivated; and
a PHY device communicatively coupled to the second network port, the PHY device operable in the shared network interface mode to receive and execute a command to control the indicator to indicate that the second network port is deactivated.

5. The information handling system of claim 1, wherein the MAC device of the second processor and the LOM of are communicatively coupled in the shared network interface mode by a media-independent interface (MII).

6. The information handling system of claim 1, wherein the first and second network ports comprise RJ45 connection devices.

7. The information handling system of claim 1, wherein:
in the dedicated network interface mode:
the MAC device of the second processor and the second network port are communicatively coupled such that the second processor may communicate out-of-band traffic with a network management node via the second network port; and
the first processor is communicatively coupled to one or more network nodes via the LOM such that the first processor may communicate in-band traffic with the one or more network devices via the first network port; and
in the shared network interface mode:
the MAC device of the second processor and the LOM of the motherboard are communicatively coupled such that the second processor may communicate out-of-band traffic with the network management node via the first network port and the LOM;
the first processor is communicatively coupled to the one or more network nodes via the LOM such that the first processor may communicate in-band traffic with the one or more network devices via the first network port; and
the second network port is deactivated.

8. A method for providing optional dedicated or shared network interface functionality, comprising:
providing a user interface for selecting between a dedicated network interface mode and a shared network interface mode for a network interface system associated with an information handling system, the network interface system including a motherboard and a remote management card;
wherein the motherboard includes a LAN on motherboard (LOM), a first processor, and a first network port operable to receive a first coupling device for communicatively coupling the first processor to one or more network nodes via the LOM;
wherein the remote management card includes a second network port and a second processor including a MAC device, the second network port operable to receive a second coupling device for communicatively coupling the second processor to one or more network nodes;
receiving from a user via the user interface a selection of the dedicated network interface mode or the shared network interface mode for the network interface system;
based on the selection received from the user, configuring the network interface system for either the dedicated network interface mode or the shared network interface mode;
wherein configuring the network interface system for the dedicated network interface mode includes communicatively coupling the MAC device of the second processor to the second network port such that the second processor may communicate with a network management node via the second network port; and
wherein configuring the network interface system for the shared network interface mode includes communicatively coupling the MAC device of the second processor to the first network port via the LOM of the motherboard such that the second processor may communicate with the network management node via the first network port.

9. The method of claim 8, wherein:
the remote management card further includes a multiplexer device having a first state and a second state;
configuring the network interface system for the dedicated network interface mode includes configuring the multiplexer device to the first state to communicatively couple the MAC device of the second processor with the second network port by configuring a multiplexer device; and
configuring the network interface system for the shared network interface mode includes configuring the multiplexer device to the first state to communicatively couple the MAC device of the second processor with the LOM of the motherboard.

10. The method of claim 8, wherein configuring the network interface system for the shared network interface mode further includes deactivating the second network port of the remote management card.

11. The method of claim 8, wherein:
the remote management card further includes an indicator operable to indicate to a user whether the second network port is activated or deactivated; and
configuring the network interface system for the shared network interface mode further includes controlling the indicator to indicate that the second network port is deactivated.

12. The method of claim 8, wherein configuring the network interface system for the shared network interface mode includes not communicatively coupling the MAC device of the second processor with the second network port such that the second processor may not communicate with the network management node via the second network port.

13. The method of claim 8, wherein:
configuring the network interface system for the dedicated network interface mode includes communicatively coupling the MAC device of the second processor with the second network port such that the second processor may communicate out-of-band traffic with the network management node via the second network port;
wherein in the dedicated network interface mode, the first processor is communicatively coupled to one or more network nodes via the LOM such that the first processor may communicate in-band traffic with the one or more network devices via the first network port;
configuring the network interface system for the shared network interface mode includes communicatively coupling the MAC device of the second processor with the LOM of the motherboard are communicatively coupled such that the second processor may communicate out-of-band traffic with the network management node via the first network port and the LOM; and
wherein in the shared network interface mode, the first processor is communicatively coupled to the one or more network nodes via the LOM such that the first processor may communicate in-band traffic with the one or more network devices via the first network port.

14. The method of claim 8, wherein communicatively coupling the MAC device of the second processor with the LOM of the motherboard in the shared network interface mode comprises communicatively coupling the MAC device with the LOM via a media-independent interface (MII).

15. A computer-readable medium having computer-executable instructions for providing optional dedicated or shared network interface functionality, comprising:
instructions for providing a user interface for selecting between a dedicated network interface mode and a shared network interface mode for a network interface system associated with an information handling system, the network interface system including a motherboard and a remote management card;
wherein the motherboard includes a LAN on motherboard (LOM), a first processor, and a first network port operable to receive a first coupling device for communicatively coupling the first processor to one or more network nodes via the LOM;
wherein the remote management card includes a second network port and a second processor including a MAC device, the second network port operable to receive a second coupling device for communicatively coupling the second processor to one or more network nodes;
instructions for receiving from a user via the user interface a selection of the dedicated network interface mode or the shared network interface mode for the network interface system; and
instructions for configuring the network interface system for either the dedicated network interface mode or the shared network interface mode based on the selection received from the user;
wherein configuring the network interface system for the dedicated network interface mode includes communicatively coupling the MAC device of the second processor to the second network port such that the second processor may communicate with a network management node via the second network port; and
wherein configuring the network interface system for the shared network interface mode includes communicatively coupling the MAC device of the second processor to the first network port via the LOM of the motherboard such that the second processor may communicate with the network management node via the first network port.

16. The computer-readable medium of claim 15, wherein:
the remote management card further includes a multiplexer device having a first state and a second state;
the instructions for configuring the network interface system for the dedicated network interface mode include instructions for configuring the multiplexer device to the first state to communicatively couple the MAC device of the second processor with the second network port by configuring a multiplexer device; and
the instructions for configuring the network interface system for the shared network interface mode include instructions for configuring the multiplexer device to the first state to communicatively couple the MAC device of the second processor with the LOM of the motherboard.

17. The computer-readable medium of claim 15, wherein the instructions for configuring the network interface system for the shared network interface mode include instructions for deactivating the second network port of the remote management card.

18. The computer-readable medium of claim 15, wherein:
the remote management card further includes an indicator operable to indicate to a user whether the second network port is activated or deactivated; and
the instructions for configuring the network interface system for the shared network interface mode include instructions for controlling the indicator to indicate that the second network port is deactivated.

19. The computer-readable medium of claim 15, wherein the instructions for configuring the network interface system for the shared network interface mode include instructions for not communicatively coupling the MAC device of the second processor with the second network port such that the second processor may not communicate with the network management node via the second network port.

20. The computer-readable medium of claim 15, wherein:
the instructions for configuring the network interface system for the dedicated network interface mode include instructions for communicatively coupling the MAC device of the second processor with the second network port such that the second processor may communicate out-of-band traffic with the network management node via the second network port; and
the instructions for configuring the network interface system for the shared network interface mode include instructions for communicatively coupling the MAC device of the second processor with the LOM of the motherboard are communicatively coupled such that the second processor may communicate out-of-band traffic with the network management node via the first network port and the LOM.
